(19) United States
(12) Patent Application Publication
(10) Pub. No.: US 2025/0139197 A1
(43) Pub. Date: May 1, 2025

(54) POLYNOMIAL ARCTANGENT COMPUTATION AT SELECTABLY HIGH PRECISION

(71) Applicant: ORACLE INTERNATIONAL CORPORATION, Redwood Shores, CA (US)

(72) Inventors: Jeff DIAMOND, Austin, TX (US); Guang Chao WANG, San Diego, CA (US)

(21) Appl. No.: 18/384,661

(22) Filed: Oct. 27, 2023

(51) Int. Cl. G06F 17/17; G06F 1/03

(52) U.S. Cl. CPC G06F 17/17; G06F 1/03

(57) ABSTRACT

Systems, methods, and other embodiments associated with high-performance arctangent computation at arbitrarily high precision are described. In one embodiment, an example method brackets an angle to a working range of an arctangent approximation polynomial. A closest index of a lookup table to the bracketed angle is determined. An angle shift for the bracketed angle is generated that is configured to move the bracketed angle to a high-precision segment of the range segments. A shifted angle is generated based on the bracketed angle and the angle shift. The arctangent approximation polynomial is evaluated at the shifted angle to produce an estimated arctangent of the shifted angle. A pre-computed arctangent corresponding to the closest index in the lookup table is retrieved from the lookup table in proximate memory. An augmented-precision arctangent is then generated from the estimated arctangent and the pre-computed arctangent.

### BACKGROUND

The arctangent is an extremely useful geometric and nonlinear operation that is fundamentally slow to compute. While there are known polynomial approximations to arctangent that are fast to compute, these have inherently low accuracy, making them poor for applications that employ high-precision arctangents, such as in machine learning.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of a high-performance arctangent system associated with high-performance arctangent computation at specified precision.

FIG. 2 illustrates one embodiment of a lookup table generation method associated with associated with high-performance arctangent computation at specified precision.

FIG. 3 illustrates one embodiment of an augmented-precision arctangent generation method associated with high-performance arctangent computation at specified precision.

FIGS. 4A and 4B show a plots of residuals between the actual arctangent function and various approximations of the arctangent function.

FIG. 5 illustrates one embodiment of a high-performance arctangent method associated with associated with high-performance arctangent computation at specified precision.

FIG. 6 illustrates an embodiment of a computing system configured with the example systems and/or methods disclosed.

### DETAILED DESCRIPTION

Systems and methods are described herein that provide a design method and implementation system for high performance arctangent computation at arbitrarily high precision. In one embodiment, a high-performance arctangent system generates a compact lookup table for shifting the arctangent calculation into a high-precision range where the polynomial is accurate to a target level of precision and then returning the precise results to the original range. In this way, the precision of a polynomial approximation of the arctangent function may be augmented using angle shifting.

Previous approaches to generation of arctangents at high levels of precision (such as 64-bit or double precision) are too slow—that is, take too many processor cycles—to allow for use of the previous approaches in time-sensitive or real-real time applications. But, the novel approach to arctangent generation by the high-performance arctangent system generates floating point arctangents at arbitrarily high precision (including full double precision (64-bit) floating point arctangents) in software, with similar rapidity to polynomial approaches that have only a tiny fraction of this precision. This substantially improved calculation speed for high-precision arctangents enables real-time computation of high-precision arctangents for machine learning, 3D-rendering, physical simulation, and other applications.

High-precision computation of arctangents has been generally accepted to be impractically slow for use in computing activities that make use of rapidly generated arctangents, thus constraining the computing activities to low precision. Despite decades of efforts by experts, rapid computation of arctangents at high precision has been unavailable. In one embodiment, the high-performance arctangent generation systems and methods described herein provide rapid computation of arctangents at high precision. In one embodiment, the high-performance arctangent generation systems and methods described herein significantly improve performance by simplifying arctangent calculation in an unexpected way. In general, one would not consider using a lower-accuracy polynomial approximation for producing high-precision arctangent results. And, one would not consider using a lookup table for performance enhancement because the added latency of accessing the table in main memory would wipe out any performance gains.

But, in one embodiment, the high-performance arctangent system uses a lookup table in shifting the arctangent calculation to a high-accuracy range of a lower-accuracy polynomial arctangent approximation where the high-accuracy range is wide enough to allow the lookup table to be small enough to fit in low-latency registers (or other proximate memory). In this way, the high-performance arctangent generation systems and methods generate the arctangent at high precision with only the low compute time of the lower-accuracy polynomial arctangent approximation and a constant time shift operation that includes only a low-latency register or L1 cache access. In short, by using a lower-accuracy polynomial that has a broad range of high precision, the lookup table can be made small enough to minimize or eliminate latency of lookups for shift operations.

In one embodiment, at a high level, the high-performance arctangent system identifies how to partition a range of an arctangent approximation polynomial into several increments of a smaller high-precision range so as to allow a lookup table indexed to the increments to fit in proximate memory. The high-performance arctangent system then populates the lookup table with high-precision, pre-calculated arctangents. The high-performance arctangent system may then angle shift any angle for which the arctangent is requested down into the high-precision range, rapidly calculate the arctangent of the shifted angle using the polynomial, swiftly retrieve a corresponding pre-calculated arctangent from the lookup table in proximate memory, and add the two arctangents to produce the arctangent for the angle.

It should be understood that no action or function described or claimed herein is performed by the human mind. No action or function described or claimed herein can be practically performed in the human mind. Any interpretation that any action or function described or claimed herein can be performed in the human mind is inconsistent with and contrary to this disclosure.

### Definitions

As used herein, the term “high-precision range” refers to a range of angles for which the arctangent approximation polynomial is accurate to a target level of precision (such as double precision).

As used herein, the term “proximate memory” refers to processor registers or level 1 cache or other on-board memory that is integrated with a processor (and consequently rapidly accessible by the processor).

### —Example High-Performance Arctangent System—

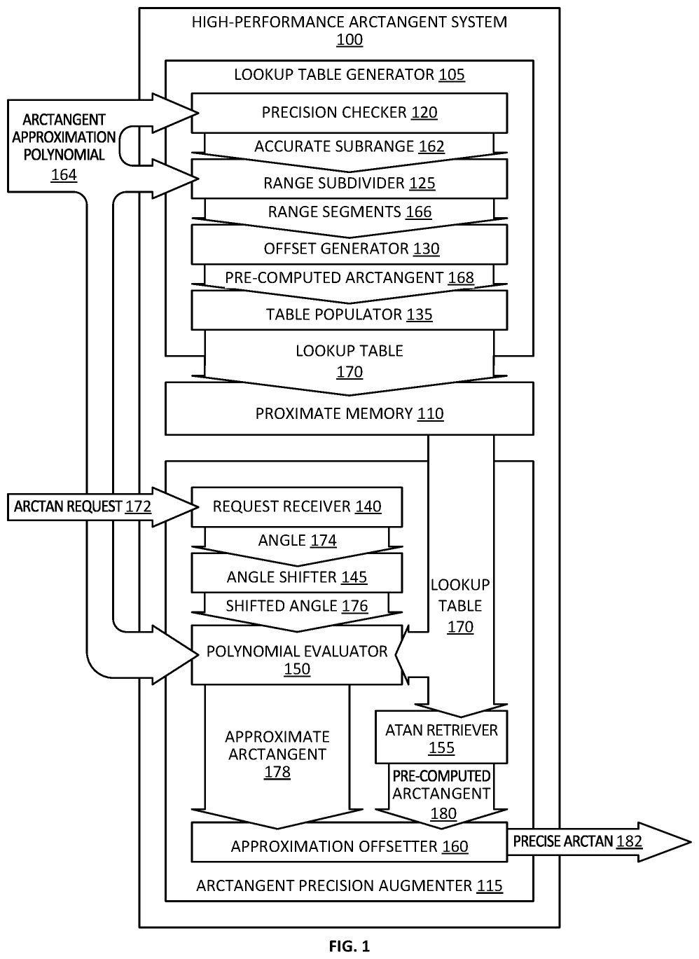

FIG. 1 illustrates one embodiment of a high-performance arctangent system 100 associated with high-performance arctangent computation at specified precision. High-performance arctangent system 100 includes components for augmenting the precision of a polynomial approximation of an arctangent of an angle using angle shifting and a lookup table of arctangent offsets. In one embodiment, the components of high-performance arctangent system 100 include a lookup table generator 105, proximate memory 110, and arctangent precision augmenter 115.

In one embodiment, the components of lookup table generator 105 include a precision checker 120, a range subdivider 125, an offset generator 130, and table populator 135. Precision checker 120 is configured to identify an accurate subrange 162 of an arctangent approximation polynomial 164 in which a target level of precision is satisfied. Range subdivider 125 is configured to subdivide the arctangent approximation polynomial 164 into a plurality of range segments 166. One high-precision segment of the range segments 166 remains within the accurate subrange 162 of the arctangent approximation polynomial 164. For each of the range segments 166, offset generator 130 is configured to pre-compute an arctangent. The pre-computed arctangent 168 is configured to offset other arctangent values from the high-precision segment to one of the range segments 166. And, for each of the range segments 166, table populator 135 is configured to write the pre-computed arctangent 168 for the range segment to a lookup table 170 in an index position corresponding to the order of the range segment.

Thus, in one embodiment, lookup table generator 105 is configured to subdivide an arctangent approximation polynomial 164 into a plurality of range segments 166, and to generate a lookup table of a plurality of pre-computed arctangents that are indexed by range segment. In one high-precision segment of the plurality of range segments 155, the arctangent approximation polynomial approximates the arctangent function at a target level of precision over the extent of the high precision segment, and the pre-computed arctangents are configured to offset arctangent values back to corresponding range segments from the high-precision segment.

In one embodiment, proximate memory 110 includes registers or level one cache. In one embodiment, table populator 135 is further configured to store lookup table 170 in proximate memory 110 (e.g., level 1 cache or registers). In one embodiment, high-performance arctangent system 100 is configured to access one of the pre-computed arctangents from the lookup table in proximate memory 110 to augment precision of a polynomial approximation of an arctangent of an angle to the target level of precision, for example using arctangent precision augmenter 115, described below.

In one embodiment, the components of arctangent precision augmenter 115 include a request receiver 140, an angle shifter 145, a polynomial evaluator 150, an arctangent retriever 155, and an approximation offsetter 160. Request receiver 140 is configured to receive a request 172 to generate an arctangent for an angle 174. Angle shifter 145 is configured to angle-shift the angle 174 to the high-precision segment. The angle-shift is based on an index position in the lookup table 170 of a range segment (of range segments 166) in which the angle 174 occurs. Polynomial evaluator 150 is configured to evaluate the arctangent approximation polynomial 164 at the shifted angle 176 to produce an approximate arctangent 178 of the shifted angle 176. Arctangent retriever 155 is configured to retrieve the pre-computed arctangent 180 for the index from the lookup table 170. Approximation offsetter 160 is configured to offset the approximate arctangent 178 of the shifted angle 176 by the pre-computed arctangent 180 for the index in order to generate the precise arctangent 182 for the (un-shifted) angle 174 at the target level of precision.

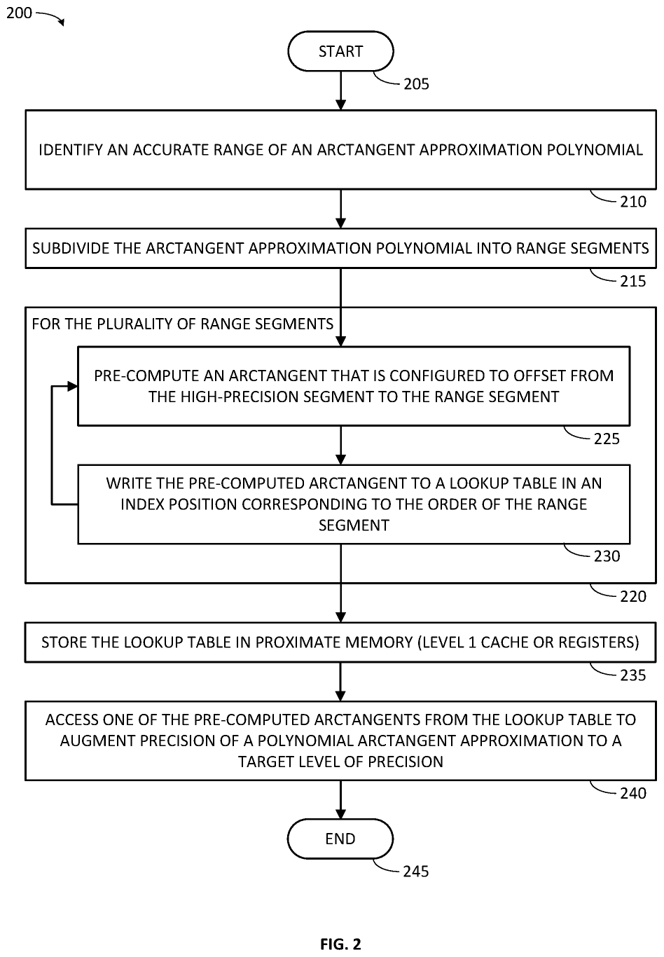

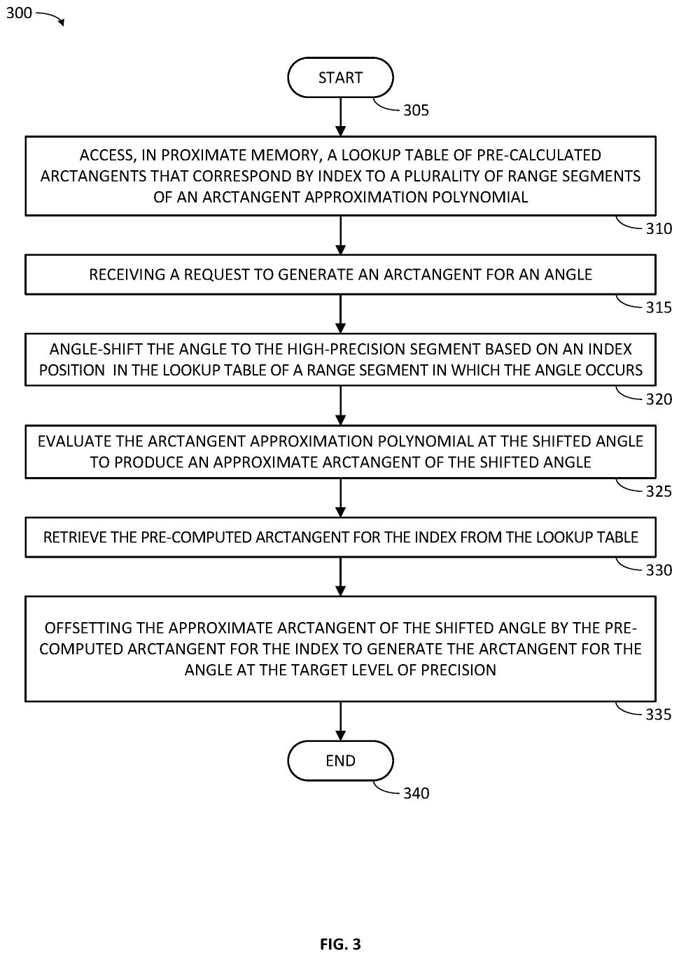

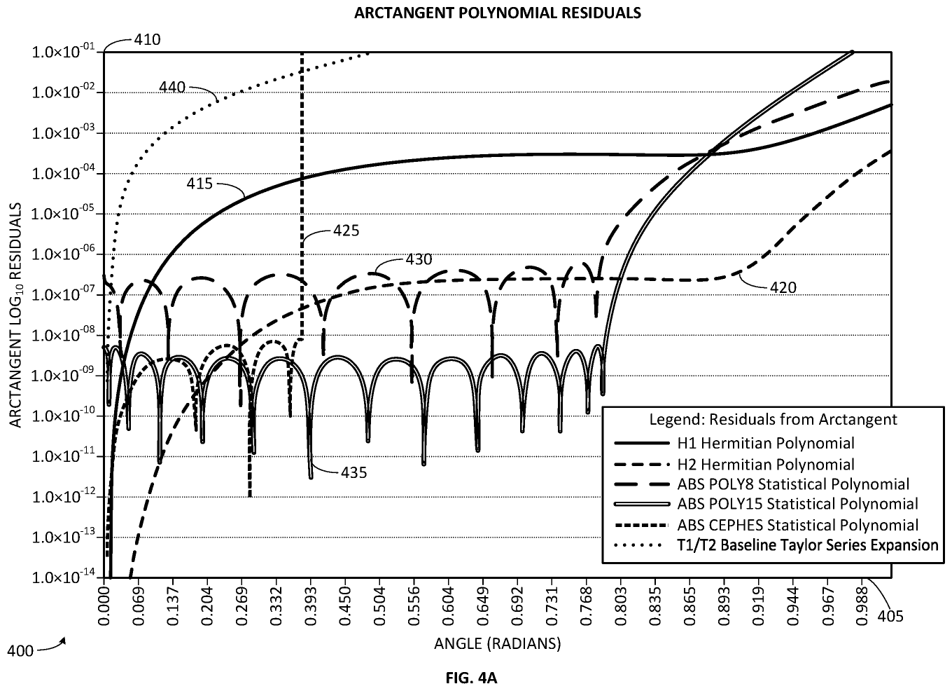

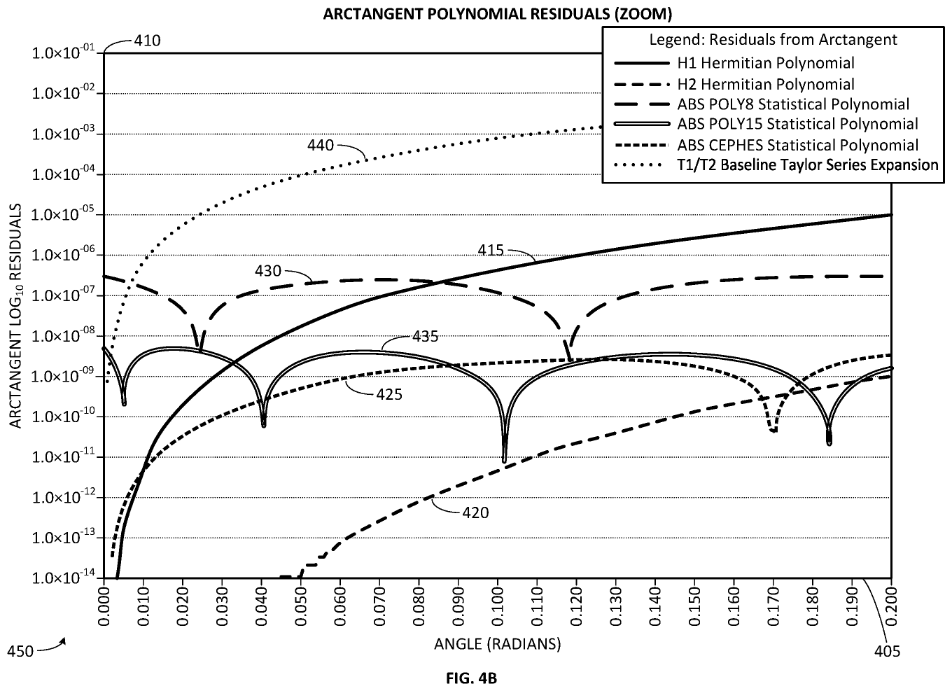

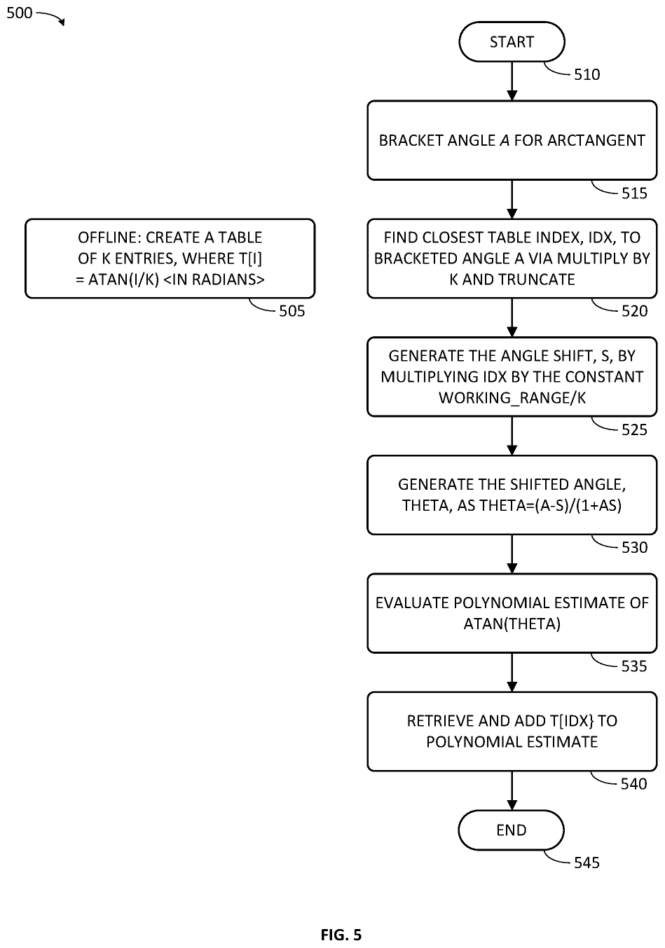

Further details regarding high-performance arctangent system 100 are presented herein. In one embodiment, operations of high-performance arctangent system 100 will be described with reference to various methods herein. Operations of lookup table generator 105 will be described with reference to example lookup table generation method 200 shown in FIG. 2. Operations of arctangent precision augmenter 115 will be described with reference to augmented-precision arctangent generation methods 300 and 500, shown with reference to FIGS. 3 and 5. Additional details regarding the high-precision segment of arctangent approximation polynomials is presented in the context of plots 400, 450 of residuals between the arctangent function and various polynomial approximations in FIGS. 4A and 4B.

### —Example Lookup Table Generation Method—

In one embodiment, as an overview, a high-performance arctangent method includes a lookup table generation phase and an augmented-precision arctangent generation phase. In one embodiment, in the lookup table generation phase, the high-performance arctangent method divides a range of interest (also referred to as a working range) of angles in an arctangent approximation polynomial into even segments or intervals. A first, high-precision segment of the segments is within a range of the arctangent approximation function that approximates the true value of the arctangent to at least a specified level of precision. The high-performance arctangent method creates a lookup table with an entry for each segment. The entry for a given segment is an actual value of arctangent for the angle at the beginning of the given segment. The actual value of arctangent is correct to at least the specified level of precision. Thus, the lookup table is a table of high-precision, pre-computed arctangents of the angles that begin each segment. The pre-computed arctangent for a given segment will be retrieved and used to offset polynomial arctangent approximations back into the given segment later in the augmented-precision arctangent generation phase.

In one embodiment, in the augmented-precision arctangent generation phase, the high-performance arctangent method angle-shifts an angle from a given segment into the high-precision segment and records the position number of the given segment in which the angle occurred. The position number of the given segment is an index number or key to look up the pre-computed arctangent for the given segment in the lookup table. The high-performance arctangent method evaluates the arctangent approximation polynomial for the shifted angle, producing an approximate arctangent of the shifted angle. The approximate arctangent of the shifted angle approximates the arctangent of the shifted angle at the specified level of precision. The high-performance arctangent method then offsets the approximate arctangent of the shifted angle back into the appropriate range of arctangents for the given segment by (i) retrieving the pre-calculated arctangent at the index (position number) from the lookup table and (ii) adding the pre-calculated arctangent to the approximate arctangent of the shifted angle. The combined pre-computed arctangent for the given segment and the polynomial arctangent approximation of the shifted angle generate an arctangent of the initial, unshifted angle at the specified level of precision.

FIG. 2 illustrates one embodiment of a lookup table generation method 200 associated with associated with high-performance arctangent computation at specified precision. Lookup table generation method 200 is one example process by which a lookup table of pre-calculated arctangents for returning arctangent estimates of angles shifted to a high-accuracy range of an arctangent approximation polynomial to the original range segment. In one embodiment, lookup table generation method 200 is a one-time setup process that enables augmented-precision arctangent generation method 300, described below.

In one embodiment of lookup table generation method 200, an accurate range of an arctangent approximation polynomial where the polynomial meets a minimum accuracy threshold is detected in a working range of the polynomial. The working range is split into smaller range segments that are sized to allow one segment to fit in the accurate range. Arctangents to compensate for angle shift into the high-precision range are pre-computed for each range segment. A lookup table is created to store each pre-computed arctangent in association with a corresponding range segment. The lookup table is placed into a fast-access memory location to support real-time restoration of arctangents of shifted angles back to their original ranges.

In one embodiment, lookup table generation method 200 initiates at START block 205 in response to determining by a frequency-domain clustering system one or more of (i) that a high-performance arctangent system has received a selection of an arctangent approximation polynomial; (ii) that an instruction to perform lookup table generation method 200 on an arctangent approximation polynomial has been received (iii) a user or administrator of a high-performance arctangent system has initiated lookup table generation method 200; (iv) it is currently a time at which lookup table generation method 200 is scheduled to be run; or (v) that lookup table generation method 200 should commence in response to occurrence of some other condition. In one embodiment, a computer system configured by computer-executable instructions to execute functions of high-performance arctangent system 100 executes lookup table generation method 200. Following initiation at start block 205, lookup table generation method 200 continues to block 210.

At block 210, lookup table generation method 200 identifies an accurate range of an arctangent approximation polynomial in which a target level of precision is satisfied. In other words, lookup table generation method 200 finds the part of the polynomial where the polynomial tracks the actual arctangent function with at least a pre-specified level of accuracy. In one embodiment, the accurate range is detected based on residuals between the arctangent function and the arctangent approximation polynomial.

Note, in one embodiment, the arctangent approximation polynomial that is under consideration herein is a working range of the unbounded arctangent approximation polynomial. The working range includes a range of angle values, for example, angles between 0 and 1 radians. Or, for example, angles between 0 and π/2 radians (the positive principal range of the arctangent function). Thus, the accurate range of the arctangent approximation polynomial is more particularly an accurate segment or portion of the working range. Further, because the arctangent function is symmetrical about the origin, arctangent values for angles below 0 are also supplied by the arctangent approximation polynomial. Thus, for a working range of 0 to 1 radians, the working range practically covers the range from −1 to 1 radians. Additional detail regarding the working range is described herein with reference to process block 515.

In one embodiment, lookup table generation method 200 sets the target level of precision. A value for the target level of precision may be pre-specified in the high-performance arctangent system. The pre-specified value for the target level may be retrieved from storage. Or, the high-performance arctangent system may be configured to present a prompt in a user interface to specify the target level of precision. A value for the target level of precision may be received as user input in response to the prompt.

In one embodiment, the lookup table generation method 200 chooses an arctangent approximation polynomial to be used. An arctangent approximation polynomial may be pre-selected in the high-performance arctangent system. The pre-selected function may be retrieved from storage. Or, the high-performance arctangent system may be configured to present a prompt in a user interface to select from among a plurality of available arctangent approximation polynomials. For example, a user may be prompted to select between the H1 and H2 Hermitian polynomial approximations (described in further detail herein). A choice of one arctangent approximation polynomial may be received as user input in response to the prompt.

In one embodiment, the lookup table generation method 200 generates the residuals between the selected arctangent approximation polynomial and the arctangent function over the working range. For example, the residuals (differences) between the H2 Hermitian polynomial approximation of arctangent and the GLIBC atan function are found for angles between the bounds that define the working range. Then, starting at angle 0 and working upward in angle, the residuals are then compared to the target level of precision. Where the residual at an angle is less than or equal to the target level of precision, increase an upper boundary of the accurate range to include the angle. Once the residual at an angle becomes greater than the target level of precision, cease increasing the upper boundary of the accurate range. In this way, upper boundary of the accurate range is discovered. The lower boundary of the accurate range is 0.

At the conclusion of block 210, the boundaries of the accurate range are established. Within the accurate range, the arctangent approximation polynomial does not deviate from the arctangent function by more than the specified precision. In one embodiment, the steps of block 210 are performed by precision checker 120 of lookup table generator 105.

At block 215, lookup table generation method 200 subdivides the arctangent approximation polynomial into a plurality of range segments for which one high-precision segment of the range segments remains within the accurate subrange. In other words, the lookup table generation method 200 separates or partitions the working range of the arctangent approximation polynomial into several smaller sections. The sections or segments are sized so that one of the sections fits within the accurate range.

In one embodiment, the range segments are of equal size. In one embodiment, the lookup table generation method 200 automatically finds the smallest number of range segments that will cover the working range while ensuring that the high-precision segment that begins at the angle of 0 fits within the accurate range. For example, beginning with a current position at the upper boundary of the accurate range, divide the working range by the current position and decrement the current position until a first time that the remainder is zero. The quotient where the remainder is zero is the smallest number of equally sized range segments that cover the working range while one range segment remains within the accurate range. The resulting smallest number is then set to be the number K of range segments. The one range segment that fits within the accurate range is the high-precision segment. The lower boundary of the high-precision segment is 0, and the upper boundary of the high-precision segment is the final value for the current position.

In one embodiment, it may be advantageous for the number K of range segments to be a power of 2. Accordingly, the above process for automatically segmenting the working range will further confirm whether the quotient with a zero remainder is a power of 2 or not before accepting the segmentation. If the quotient with a zero remainder is not a power of 2, the segmentation process will proceed to the next quotient with a zero remainder, until the quotient with a zero remainder is found also to be a power of 2. Where the base-2 logarithm of the quotient is an integer, the quotient is a power of 2.

In one embodiment, the number K of range segments may be affected by the end application. In one embodiment, the number K of range segments may be constrained by the requirements of the hardware on which the high-performance arctangent method is implemented. In one embodiment, the number K of range segments is constrained by a maximum size permitted for the lookup table. In one embodiment, the number K of range segments is driven by the target level of precision to be achieved.

At the completion of block 215, the number K of range segments is determined and the high-precision segment is defined. In one embodiment, the steps of block 215 are performed by range subdivider 125 of lookup table generator 105.

At block 220, lookup table generation method 200 enters a loop that repeats for the plurality of range segments in ascending order. The loop serves to populate a lookup table with pre-computed arctangents. The pre-calculated arctangents that are associated with the K range segments.

At block 225, lookup table generation method 200 pre-computes an arctangent that is configured to offset from the high-precision segment to the range segment. In other words, the pre-computed arctangent is configured to recover an arctangent calculated in the high-precision segment to the given range segment. The pre-computed arctangent is thus associated with the range segment. In one embodiment, the pre-computed arctangent for a range segment is based on the position of the range segment among the K range segments. In one embodiment, the positions of the range segments are indexed in ascending order of the angles included in the segments. For example, the range segment beginning at angle zero (the high-precision segment) has index 1, the next range segment has index 2, and so on. Thus, in one embodiment, the index i is provided by the index of the loop of block 220. In one embodiment, the pre-computed arctangent for a range segment with index i is the arctangent of the quotient (or ratio) of index i divided by the number of range segments K (atan (i/K)). In one embodiment, the pre-computed arctangent for a range segment is generated using a commercially available arctangent function, such as atan in GLIBC. In one embodiment, the pre-computed arctangent for a range segment is generated at the target level of precision. In one embodiment, the steps of block 225 are performed by offset generator checker 130 of lookup table generator 105.

At block 230, lookup table generation method 200 writes the pre-computed arctangent to a lookup table in an index position corresponding to the order of the range segment. In one embodiment, the lookup table is a data structure. For example, the lookup table may be implemented as an array, with data values indexed or keyed by positions within the array. In one embodiment, the lookup table may thus be an array of 32-bit single precision float values, or an array of 64-bit double precision float values. The lookup table is populated over multiple iterations of the loop of block 220. An arctangent for a range segment with index i (as described at block 225 above) is written into the lookup table at position i. The position in the array that corresponds to index i is located, and the values in that position are overwritten with the pre-computed arctangent that is associated with index i. Once the arctangent for each of the K range segments has been pre-computed and stored in the lookup table, the loop completes and the lookup table is populated. In one embodiment, the steps of block 230 are performed by table populator 135 of lookup table generator 105.

At block 235, lookup table generation method 200 stores the lookup table in proximate memory (level 1 cache or registers). For example, where a 64-bit processor has 16 general-purpose 64-bit registers, the individual arctangents in the array may be distributed across these 16 registers (although several of these registers need to remain free for other processing tasks). So, for example, where the array is of length K=4 for 4 range segments, the 4 64-bit arctangents may be maintained in 4 of the registers for immediate lookup access. In one embodiment, the lookup table generation method 200 executes a load operation to place each arctangent value in the lookup table into a specific register. Or, for example, where K is too large to be conveniently maintained in registers alone, the arctangents of the lookup table may be stored in level 1 cache for rapid lookup access. For example, a single cache line of level 1 cache will typically hold 8 doubles. So, if the lookup table includes only K=8 64-bit arctangent entries, the lookup table could be accessed with only a single load operation.

In one embodiment, the steps of block 235 are performed by lookup table generator 105 to place the lookup table into proximate memory 110. At the conclusion of block 235, having iterated through the loop for all range segments, a lookup table has been generated. The lookup table may be stored in proximate memory, and the arctangent values stored therein may be used to recover arctangent values calculated in the high-precision range back to their original ranges. In one embodiment, additional details regarding creation of a lookup table are described below with reference to block 505.

At block 240, lookup table generation method 200 accesses one or more of the pre-computed arctangents from the lookup table in the proximate memory to augment precision of a polynomial approximation of an arctangent of an angle to the target level of precision. In other words, lookup table generation method 200 retrieves the pre-calculated arctangent values from registers or level 1 cache and uses them to make arctangent estimates produced with the arctangent approximation polynomial more accurate. In particular, an angle is shifted from a given range segment (having a given index) into the high-precision segment and the arctangent approximation function is executed on the shifted angle to produce an arctangent estimate for the shifted angle at the target level of precision. Then, the pre-calculated arctangent for the given range segment is found in the lookup table, and used to convert the arctangent back to the given range segment. To retrieve an arctangent value for a given index, a lookup operation searches the lookup table for the index and returns the arctangent value in the position that is associated with the index. In one embodiment, pre-computed arctangents are accessed from the lookup table in proximate memory to augment polynomial approximation in a manner similar to that described below with reference to augmented-precision arctangent generation method 300.

### —Example Augmented-Precision Arctangent Generation Method—

FIG. 3 illustrates one embodiment of an augmented-precision arctangent generation method 300 associated with high-performance arctangent computation at specified precision. Augmented-precision arctangent generation method 300 is one example process by which the precision of a fast polynomial approximation of the arctangent function may be boosted based on (i) angle shifting to a high-precision region of the approximation for arctangent generation and (ii) obtaining pre-calculated offsets from a lookup table in a fast memory location and applying them to the generated arctangents to compensate for the angle shift.

In one embodiment, augmented-precision arctangent generation method 300 initiates at START block 305 in response to determining by a frequency-domain clustering system one or more of (i) that a high-performance arctangent system has received one or more angles for which arctangents are to be generated; (ii) that an instruction to perform augmented-precision arctangent generation method 300 on one angle or a batch of angles has been received (iii) a user or administrator of a high-performance arctangent system has initiated augmented-precision arctangent generation method 300; (iv) it is currently a time at which augmented-precision arctangent generation method 300 is scheduled to be run; or (v) that augmented-precision arctangent generation method 300 should commence in response to occurrence of some other condition. In one embodiment, augmented-precision arctangent generation method 300 initiates following completion of lookup table generation method 200. In one embodiment, a computer system configured by computer-executable instructions to execute functions of high-performance arctangent system 100 executes augmented-precision arctangent generation method 300. Following initiation at start block 305, augmented-precision arctangent generation method 300 continues to block 310.

At block 310, augmented-precision arctangent generation method 300 accesses, in proximate memory (level 1 cache or registers), a lookup table of pre-calculated arctangents that correspond by index to a plurality of range segments of an arctangent approximation polynomial. The range segments include a high-precision segment at a target level of precision. In one embodiment, the lookup table of block 310 may be generated by lookup table generator 105 in a manner similar to that described above at blocks 210-235. In one embodiment, accessing the lookup table includes manipulating, retrieving, or otherwise performing operations on one or more pre-computed arctangents from the proximate memory. For example, the processor may address a particular register that includes a pre-computed arctangent and execute a read or other instruction using that pre-computed arctangent. Or, for example, the processor may load a pre-computed arctangent at a memory address in L1 cache into a register for subsequent operations.

At block 315, augmented-precision arctangent generation method 300 receives a request to generate an arctangent for an angle. In one embodiment, the request is presented to the high-performance arctangent system by one or more systems that are external to the high-performance arctangent system, including client software applications. In one embodiment, the request is presented as a call to execute a function that is configured to perform augmented-precision arctangent generation method 300. In one embodiment, the request is a message data structure (such as a REST request). In one embodiment, the request is a processor instruction. In one embodiment, the request is a bulk request including a plurality of angles for which arctangents are to be generated. The augmented-precision arctangent generation method 300 accepts the request and parses the request to extract the angle(s) from the request. The angle(s) are stored for subsequent processing. At the conclusion of block 315, one or more angles for which arctangents are to be generated have been made available for evaluation. In one embodiment, the steps of block 315 may be performed by request receiver 140 of arctangent precision augmenter 115.

At block 320, augmented-precision arctangent generation method 300 angle-shifts the angle to the high-precision segment based on an index position in the lookup table of a range segment in which the angle occurs. For example, the angle is relocated or converted to a different angle that falls within the range where polynomial estimates of the arctangent satisfy the target precision level. The relocation of the angle is based on the position of the range segment relative to the other range segments, as described by the index position. In one embodiment, as an initial step, augmented-precision arctangent generation method 300 angle shifts (or “brackets”) the angle into the working range of the arctangent approximation polynomial (for example as described with reference to block 515 below). Augmented-precision arctangent generation method 300 determines and records the range segment (index) of the working range at which the angle occurs (for example as described with reference to block 520 below).

Augmented-precision arctangent generation method 300 then generates an angle shift S to transfer the angle A into the high-precision segment of the working range (for example as described with reference to block 525 below). The angle shift S is based on an angular size of the working range and a number or count of range segments in the working range. Based on the generated angle shift, Augmented-precision arctangent generation method 300 generates a shifted angle θ from the angle A and the angle shift S (for example as described with reference to block 530). At the conclusion of block 320, the shifted angle θ is in the high-precision segment of the arctangent approximation polynomial. In one embodiment, the shifted angle θ is stored for subsequent operations, for example in a register or other proximate memory. In one embodiment, the steps of block 320 may be performed by angle shifter 145 of arctangent precision augmenter 115.

At block 325, augmented-precision arctangent generation method 300 evaluates the arctangent approximation polynomial at the shifted angle to produce an approximate arctangent of the shifted angle. In other words, an approximate arctangent value for the shifted angle is generated by plugging the shifted angle into the arctangent approximation polynomial.

In one embodiment, the augmented-precision arctangent generation method 300 retrieves the arctangent approximation polynomial from memory. In one embodiment, the arctangent approximation polynomial is also maintained in proximate memory. The arctangent approximation polynomial is broken down into individual coefficients of the powers of the shifted angle θ and the coefficients are stored in an array where each position corresponds to a certain power of shifted angle θ. For example, as shown at EQ. 2 below, the H2 Hermitian polynomial has 11 terms, and the 11 coefficients of these terms may be stored in an array of 11 elements. As a single cache line of level 1 cache will typically hold 8 doubles, the array of coefficients may be represented in as few as two cache lines of L1 cache.

In one embodiment, the coefficients are retrieved from the L1 cache. The value of shifted angle θ is inserted into the powers of θ for the arctangent approximation polynomial, the corresponding coefficients for the powers of θ are applied, and the operations carried out to resolve the arctangent approximation polynomial for the value of shifted angle θ. The result is an approximate arctangent of the shifted angle. The approximate arctangent is stored for subsequent operations, for example in a register or other proximate memory. Because the approximate arctangent was determined for a shifted angle that is in the high-precision range, the approximate arctangent of the shifted angle approximates the exact arctangent within the target level of precision.

At the conclusion of block 325, an approximate arctangent has been generated to arbitrary precision (for example, 32-bit single precision, 64-bit double precision, or other target precision level specified by the user or client application) by evaluating a polynomial of 11 terms. By comparison, the standard implementation of the atan function in GLIBC can exceed 1000 terms to reach 32-bit single precision. Evaluation of the compact (e.g., 11-term) arctangent approximation polynomial leaves a substantial amount of processing time in which to perform brief constant-time operations to map the approximate arctangent back to its original range segment, as discussed below. In one embodiment, additional detail about evaluating the arctangent approximation polynomial at the shifted angle is discussed elsewhere herein with reference to block 540. In one embodiment, the steps of block 325 may be performed by polynomial evaluator 150 of arctangent precision augmenter 115.

At block 330, augmented-precision arctangent generation method 300 retrieves the pre-computed arctangent for the index from the lookup table in proximate memory. In one embodiment, the method retrieves the index for the original range segment of the working range at which the angle occurred (or was bracketed into) from the location where the index was stored at block 320. The method 300 then searches the array that makes up the lookup table for the index. Upon detecting the index in the lookup table, method 300 returns the pre-computed arctangent value associated with the index. At the completion of block 330, the pre-computed arctangent has been obtained. The pre-computed arctangent is configured to offset the arctangent approximation back to the range segment of the original angle. In one embodiment, the steps of block 330 may be performed by arctangent retriever 155 of arctangent precision augmenter 115.

At block 335, augmented-precision arctangent generation method 300 offsets the approximate arctangent of the shifted angle by the pre-computed arctangent for the index to generate the arctangent for the angle at the target level of precision. In short, the approximate arctangent of the shifted angle is combined with the pre-computed arctangent to compensate for the angle shift. In this way, the high-precision approximate arctangent shifted angle is modified to be consistent with calculation of the original, un-shifted angle while retaining the target level of precision. In other words, the approximate arctangent is rectified to place the approximate arctangent within the angular bounds of the original range segment.

In one embodiment, the approximate arctangent of the shifted angle and the pre-computed arctangent are summed in order to generate an angle in the original range for which the precision is augmented. In one embodiment, the processor may address a first register R1 containing a pre-computed arctangent that compensates for angle shifts from a range segment and a second register R2 containing a polynomial approximation of an arctangent of an angle that was angle-shifted from the range segment with an add function (e.g., “ADD R1, R2”) to produce an augmented-precision arctangent. Because both the approximate arctangent and the pre-computed arctangent comply with the target level of precision, the resulting augmented-precision arctangent also satisfies the target level of precision.

Thus, at the conclusion of block 335, the augmented-precision arctangent generation method 300 has generated an arctangent for an angle at a high level of precision in a far shorter compute time than was previously possible when using standard approaches. In one embodiment, the steps of block 335 may be performed by approximation offsetter 160 of arctangent precision augmenter 115.

Following the conclusion of block 335, augmented-precision arctangent generation method 300 may re-iterate indefinitely from block 315 to generate further arctangents for further angles, or proceed to end block 340, where augmented-precision arctangent generation method 300 terminates. Further, method 300 may be implemented for multiple angles simultaneously using parallel processing. Where the working range of the arctangent approximation polynomial is consistent across multiple angle requests, copies of one lookup table (generated in accordance with method 200) may be distributed to and used by various parallel processing units.

### Further Embodiments of Example Methods

In one embodiment, pre-computing an arctangent (as discussed above at process block 225 and below at process block 505) further includes, for each range segment, generating an arctangent of a ratio of (i) an index position of the range segment to (ii) a total count of the plurality of range segments at the target level of precision. The arctangent of this ratio is calculated and stored in the lookup table at the index position for the range segment to be the pre-computed arctangent for the range segment.

In one embodiment, accessing one of the pre-computed arctangents from the lookup table in the level 1 cache or registers to augment precision of a polynomial approximation of an arctangent of an angle to the target level of precision (as discussed above with reference to block 240) further includes steps to generate arctangents for angles based on augmented- or enhanced-precision of arctangent approximation polynomials, as follows. Lookup table generation method 200 receives a request to generate the arctangent for the angle (as discussed further at block 315). Method 200 angle-shifts the angle to the high-precision segment based on an index position in the lookup table of a range segment in which the angle occurs (as discussed further at blocks 320 and 520-530). Method 200 evaluates the arctangent approximation polynomial at the shifted angle to produce an approximate arctangent of the shifted angle (as discussed further at blocks 325 and 535). Method 200 retrieves the one of the pre-computed arctangents in the index position from the lookup table (as discussed further at blocks 330 and 540). Method 200 offsets the approximate arctangent of the shifted angle by the pre-computed arctangent in the index position to generate the arctangent for the angle at the target level of precision (as discussed at blocks 335 and 540).

In one embodiment, identifying the accurate range (as discussed above at block 210) further includes identifying the accurate subrange based on residuals between the arctangent function and the arctangent approximation polynomial.

In one embodiment, subdividing the arctangent approximation polynomial into a plurality of range segments (as discussed above at block 215) further comprises subdividing the range into a fewest segments for which the one high-precision segment of the range segments remains within the accurate subrange.

In one embodiment, evaluating the arctangent approximation polynomial at the shifted angle (as discussed at blocks 325 and 535) augments a precision of the generated arctangent for the angle.

In one embodiment, the target level of precision is 32-bit precision, and the arctangent for the angle is generated at the target level of precision using no more than two pre-computed arctangents in the lookup table.

In one embodiment, the target level of precision is 64-bit precision, and the arctangent for the angle is generated at the target level of precision using no more than 16 pre-computed arctangents in the lookup table.

In one embodiment, augmented-precision arctangent generation method 300 further includes maintaining the lookup table in registers or level 1 cache (proximate memory). As used herein with reference to the lookup table, the term “maintaining” refers to holding the lookup table in proximate memory during the execution of method 300, thereby providing rapid and/or real-time access to the pre-calculated arctangents in the lookup table to the functions that use such access.

In one embodiment, the arctangent approximation polynomial is a Hermitian polynomial (as discussed in further detail below).

In one embodiment, augmented-precision arctangent generation method 300 further includes accepting a selection of the arctangent approximation polynomial (as discussed at block 210). The arctangent approximation polynomial selected is one of an H1 Hermitian polynomial, an H2 Hermitian polynomial.

In one embodiment, the high-precision segment covers angles nearest to zero out of the plurality of range segments (as discussed, for example, at blocks 215, 225 and 525)

In one embodiment, augmented-precision arctangent generation method 300 further includes generating a light transformation in 3D rendering, otherwise determining angles for computer graphics, executing an activation function in a neural network using the generated arctangent, otherwise generating a machine learning estimate, measuring distance on an ellipsoid for navigation, or calculating phase in digital signal processing. Bulk group of arctangent calculations may be performed for the above applications. In one embodiment, the high-performance arctangent systems enables the bulk groups of arctangent calculations to be performed in real time where this was not previously possible to computers. In one embodiment, augmented-precision arctangents produced as described herein may be used in light transformations in computer graphics and computer vision to calculate angles, determine surface normals, and simulate the behavior of light rays all with improved precision. The improved precision of the arctangent increases the realism of rendering of lighting and shading effects in 3D environments. In one embodiment, augmented-precision arctangents produced as described herein may be used in machine learning for generating estimates, such as in neural network, statistical regression, and decision tree-based machine learning models. The improved precision of the arctangent increases the accuracy of the generated estimates.

In one embodiment, the arctangent is generated in real time at the target level of precision. In one embodiment, the augmented-precision arctangent is generated in real time at the target level of precision for a plurality of angles. In one embodiment, a plurality of augmented-precision arctangents are generated in real time for a bulk request of angles. For example, a bulk request for arctangents for rendering a frame of computer animation. Or, for example, a bulk request for arctangents for generating machine learning estimates for a stream of observations, such as by using the arctangents as activation functions for a plurality of neurons in a neural network that is monitoring the stream of operations. In one embodiment, these augmented-precision arctangents are produced in parallel.

In one embodiment, augmented-precision arctangent generation method 300 further includes computing the pre-computed arctangents at or beyond the target level of precision based on Taylor series expansion. For example, the pre-computed arctangents may be calculated using the GLIBC atan function, which computes the arctangent function using a Taylor series.

In one embodiment. prior to angle-shifting the angle to the high-precision segment, arctangent generation method 300 further includes bracketing the angle to a working range of the arctangent approximation polynomial (as discussed at blocks 320 and 515).

### Discussion and Additional Embodiments

The arctangent is an extremely useful geometric and nonlinear operation that is fundamentally slow to compute. While there are known polynomial approximations to arctangent that are fast to compute—on average 100,000 times faster than atan function in the GNU C Library (GLIBC)—these arctangent approximation polynomials have inherently low accuracy. The low accuracy makes arctangent approximation polynomials useful for games or rough lighting simulation, but poor for applications that require high precision arctangents, such as machine learning and realistic 3D rendering. For statistical series, terms can be added to the series to increase accuracy for smaller angles, but for larger angles, this quickly becomes impractical, as hundreds of terms are needed. For mathematically derived series, terms cannot be added, and new series are needed. As one example, a state-of-the-art mathematically derived series would need over 300 terms to approach double precision results.

Thus, before the augmented-precision arctangent generation systems and methods presented herein, the compute time for accurate arctangent calculations limited processes that employ many arctangent calculations to low accuracy in order to achieve processing speeds at or near real-time. For example, machine learning processes have been constrained to as little as 4-bit precision in arctangents in order to achieve the required processing accuracy. But, with the augmented-precision arctangent generation systems and methods presented herein, the compute time for accurate arctangent calculations is reduced by many orders of magnitude, improving the available accuracy of arctangent calculations at real-time processing speeds. In this way, the augmented-precision arctangent generation systems and methods presented herein improves the functioning of the computer to produce more accurate arctangents per amount of computing time, without requiring upgrade of the computing hardware.

The high-performance arctangent system leverages two elements to produce a high-performance polynomial (i.e., a polynomial with a small number of terms and coefficients) that can then be augmented to compute arctan to an arbitrarily high precision with only a constant additional computation step. By leveraging existing polynomial series approximations for arctangent, along with the trigonometric relations for angle shifting, extremely small lookup tables (with as few as 2 entries) may be employed to massively increase the accuracy of the baseline arctangent computation. By having such a small lookup table, much more efficient software implementations are enabled on a wide class of compute platforms. The end result is a computational system that can match the speed of the fastest low precision arctan computations with better precision than the highest-precision existing polynomial computations. In one embodiment, High-performance arctangent system 100 can achieve 64-bit arctan computations 100,000 times faster than the GLIBC standard implementation. Note that the standard implementation can easily exceed 1000 terms just to reach single (32-bit) precision.

The table-based lookup approach employed by the high-performance arctangent system may be used to arbitrarily enhance the accuracy of existing low precision, low complexity polynomial approximations to arctangent with constant additional overhead to the compute cost. In one embodiment, this approach is enabled by leveraging properties of Hermitian approximations to arctangent which allow extremely small tables to provide extremely large boosts in accuracy. While the algebraic transformations applied to leverage the properties of the high-precision range of polynomial approximations may also be employed for standard angle bracketing in standard arctangent computation, their use by the high-performance arctangent system 100 to increase precision via a table lookup as described herein has never before been performed.

In one improvement, in one embodiment the high-performance arctangent system yields the first practical high performance polynomial series that can compute 64-bit precision arctangents in as few as 6 polynomial terms. In one embodiment, when implemented with single instruction, multiple data (SIMD) parallel processing and/or batch computation, high-performance arctangent system easily achieves more than one full (32-bit) precision arctangent per nanosecond on a single core. In another improvement, in one embodiment the high-performance arctangent system enables a wide range of tunable implementation strategies depending on the desired accuracy, speed, and implementation considerations, as will be described in further detail below. In yet another improvement, in one embodiment the high-performance arctangent system this takes machine learning algorithms (and other algorithms) that are performance-bound by slow conventional arctangent computation and opens up brand new applications for these algorithms as lightweight, real-time algorithms.

As yet another improvement, in one embodiment the high-performance arctangent system can take a 12-term polynomial series (having less than 32-bit precision) approximation to arctan (x), and increase its accuracy to full 32-bit precision with a lookup table of just 2 entries, and to full 64-bit precision using a lookup table with just 16 entries. Note that tables this small can be stored in SIMD registers or other proximate memory. When starting with a very low precision 6 term polynomial approximation to the arctangent function that is accurate to only 3 decimal digits, the high-performance arctangent system can achieve full 32-bit accuracy with an 8-entry table, and 64-bit accuracy with 256 table entries. Even this largest table only occupies 2 KB of Level 1 cache. The additional computation used to achieve this augmented precision is just a single table lookup and a single angle shift computation. By applying the precision boost to the smaller, less accurate but faster polynomial, the additional computation time for augmenting precision is more than completely covered by the reduction in time to evaluate the polynomial. Experimentation has shown that in one embodiment, the high-performance arctangent system achieves full accuracy at minimum 100,000× the speed of the standard GLIBC implementation of arctangent.

Because the approach by the high-performance arctangent system does involve reading a table value, on some implementation architectures, it will have SIMD scaling limitations that can increase the overhead of additional computation relative to the performance of the vectorized floating-multiply-add instructions (FMADDs) used to evaluate the polynomial. In particular, for wide SIMD, complex implementations may be needed on some CPUs to prevent the lookup table becoming a bottleneck. In practice, however, in the worst case, the look-up merely doubles the speed of a very low precision computation, and matches the speed of a mid-range precision computation, therefore still reducing the time to augment the precision of a polynomial to a high level.

In one embodiment, the arctangent approximation polynomial is one of the H1 or H2 Hermitian polynomials described in Medina, H. (2006), “A Sequence of Polynomials for Approximating Arctangent,” The American Mathematical Monthly, 113 (2), 156-161 (http://digitalcommons.lmu.edu/math_fac/95). The H1 Hermitian polynomial is given by EQ. 1:

$${h}_{1} ( x ) = x - \frac{{x}^{3}}{3} + \frac{{x}^{5}}{4} - \frac{{x}^{6}}{6} + \frac{{x}^{7}}{28} \qquad EQ . 1$$

The H2 Hermitian polynomial is given by EQ. 2:

$${h}_{2} ( x ) = x - \frac{{x}^{3}}{3} + \frac{{x}^{5}}{5} - \frac{{x}^{7}}{7} + \frac{5 {x}^{9}}{48} + \frac{{x}^{10}}{20} - \frac{43 {x}^{11}}{176} + \frac{{x}^{12}}{4} - \frac{27 {x}^{13}}{208} + \frac{{x}^{14}}{28} - \frac{{x}^{15}}{240} \qquad EQ . 2$$

Overall, base H1 is accurate to 3 digits, while base H2 is accurate to 6 digits. The H1 and H2 Hermitian polynomials both have substantial high-precision ranges where the polynomials closely approximate the arctangent function. The H1 Hermitian polynomial varies from the actual arctangent function by less than 1.0×10⁻⁰⁷ (1.0E-7) between 0 and approximately 0.076 radians, allowing for arctangent calculations up to single (32-bit) precision within this range. The H1 Hermitian varies by less than 1.0×10⁻¹⁴ between 0 and approximately 0.003 radians, or less than 1.0×10⁻¹⁵ (1.0E-15) between 0 and approximately 0.002 radians, allowing for 64-bit arctangent calculations on this range. The H2 Hermitian polynomial varies from the actual arctangent function by less than 1.0×10⁻¹⁴ (1.0E-14) between 0 and approximately 0.05 radians, or less than 1.0×10⁻¹⁵ between 0 and approximately 0.039 radians, allowing for arctangent calculations up to double (64-bit) precision within this range. The H2 Hermitian polynomial varies from the actual arctangent function by less than 1.0×10⁻⁷ between 0 and approximately 0.48 radians, allowing for arctangent calculations up to single (32-bit) precision within this range.

Therefore, in one embodiment the high-performance arctangent system can augment the H1 and H2 polynomials up to an arbitrarily specified target level of precision using small lookup table of pre-calculated arctangents. Table 1 shows minimum accuracy in decimal digits for atan (x) generated by the high-performance arctangent system based on the Hermitian series H1 and H2 for a given number of lookup table (LUT) entries.

TABLE 1
ENHANCED ACCURACY

| No. of LUT Entries | H1 Digits | H2 Digits |
|---|---|---|
| 2 | 4 | 7 |
| 4 | 5 | 9 |
| 8 | 6 | 11 |
| 16 | 8 | 14 |
| 32 | 9 | 15+ |
| 64 | 11 | 15+ |
| 128 | 12 | 15+ |
| 256 | 14 | 15+ |

Thus, H2 can be boosted to single (32-Bit) precision using a table of only 2 entries, and to double (64-bit) precision using 16 entries. Each doubling of entries in the lookup table yields an approximate 100-fold increase in accuracy of the arctangent result.

In one embodiment, FIG. 4A shows a plot 400 of residuals between the actual arctangent function and various approximations of the arctangent function. The residuals are plotted against an angle axis 405 and an amplitude of residuals axis 410. The residuals are plotted over the range between 0 radians and 1 radian along angle axis 405. FIG. 4B shows a zoomed view 450 of plot 400, showing the range between 0 radians and 0.200 radians along angle axis 405.

Residuals between the actual arctangent function and the H1 Hermitian polynomial approximation are shown by H1 residuals 415. Residuals between the actual arctangent function and the H2 Hermitian polynomial approximation are shown by H2 residuals 420. Residuals between the actual arctangent function and the Cephes statistical polynomial are shown by Cephes residuals 425. (Additional documentation on the Cephes statistical polynomial is available at https://www.netlib.org/cephes/.) Residuals between the actual arctangent function and the Poly 8 statistical polynomial are shown by Poly 8 residuals 430. Residuals between the actual arctangent function and the Poly 15 statistical polynomial are shown by Poly 15 residuals 435. Residuals between the actual arctangent function and the T1, T2 baseline Taylor expansion are shown by Taylor residuals 440.

The Cephes statistical polynomial only approximates the arctangent function up to π/8 radians. Accordingly, the residuals become infinite or undefined beyond π/8 (approx. 0.393) radians. Cephes has seven terms to compute. Base Cephes accurately approximates arctangent to 8 digits. But, the Cephes statistical polynomial has no single high-precision range, and is therefore not readily augmented. The lack of a single high-precision range is visible in the roughly cycloidal (bouncing) path of Cephes residuals 425. Further, the Cephes statistical polynomial terminates before the angle reaches 0, truncating the range where precision increases as the angle approaches 0 and capping precision. Cephes therefore provides no range where precision can become arbitrarily high.

Base Poly 8 accurately approximates arctangent to 6 digits. Base Poly 15 accurately approximates arctangent to 8 digits. The Poly 8 and Poly 15 statistical polynomials are subject to the same lack of single high-precision range (visible in the bouncing paths of Poly 8 residuals 430 and Poly 15 residuals 435) that make the Cephes series unamenable to augmentation. All regions of the Poly 8 and Poly 15 statistical polynomials where increased accuracy occurs are narrow, as shown by the cusps in Poly 8 residuals 430 and Poly 15 residuals 435. Further, the Poly 8 and Poly 15 statistical polynomials are subject to floors on precision. Poly 15, for example, is never more accurate than 12 digits, providing no range where precision can become arbitrarily high.

By contrast, the H1 and H2 Hermitian polynomials have better properties for establishing a high-precision range. As is visible in H1 residuals 415 and H2 residuals 420. Both the H1 and H2 Hermitian polynomials have residuals (with respect to the actual arctangent function) that approach 0 as the angle approaches 0. Thus, as the angle becomes smaller, the arctangent approximations of the he H1 and H2 Hermitian polynomials become continually more accurate, approaching infinite accuracy as the angle approaches 0. Therefore, for any target level of precision, there exists a range in each of the H1 and H2 Hermitian polynomials for which the polynomial approximates the arctangent within the target level of precision. Therefore, in the H1 and H2 Hermitian polynomials, the precision of the arctangent approximation can become arbitrarily high over a small-enough range of angles. Therefore, even though the base H1 and H2 Hermitian polynomials may have lower overall accuracy, the H1 and H2 Hermitian polynomials have ranges in which an arbitrarily high precision may be reached (even if such ranges are small). This is a property lacked by the Cephes, Poly 8, Poly 15, and Taylor series approximations. While many polynomials may reach precision at some range, the H1 and H2 are noteworthy and useful due to the breadth of their high-precision ranges. In one embodiment, for the high-performance arctangent systems and methods described herein, the wider that the angle range for the arctangent approximation polynomial is that is within the desired precision, the better that polynomial is.

In one embodiment, other polynomial approximations of the arctangent function that share properties similar to those of the H1 and H2 polynomials may also be appropriate for providing an arbitrarily high-precision range for the high-performance arctangent system. In particular, in one embodiment, polynomial approximations of arctangent that become continually more accurate as the angle decreases, approaching infinite accuracy as the angle approaches 0, are appropriate for providing an arbitrarily high-precision range for the high-performance arctangent system. In one embodiment, other Hermitian polynomials may also be appropriate.

Table 2 shows ranges over which various polynomials have a designated accuracy. More particularly, Table 2 shows a range in degrees from zero that each series could approximate the arctangent to the designated accuracy that is shown. The range for which a polynomial approximates the arctangent with a designated accuracy has also been referred to herein as a “high precision range” of the polynomial.

TABLE 2
RANGE OF ACCURACY
Range in degrees:

| Accuracy | 1.00E−15 | 1.00E−14 | 1.00E−08 | 1.00E−07 |
|---|---|---|---|---|
| H2 Hermitian | 2.21 | 2.89 | 16.98 | 26.98 |
| H1 Hermitian | 0.10 | 0.17 | 2.71 | 4.38 |
| Cephes | 0.04 | 0.08 | 22.5 | 22.50 |
| Taylor Ser. Exp. | 0.00 | 0.00 | 0.14 | 0.30 |

The accuracy ranges for the Cephes and Taylor series expansion polynomials are shown in Table 2 for comparison with the accuracy ranges of the Hermitian polynomials. The Poly 8 and Poly 15 arctangent approximations do not produce a significant range near zero at even single precision, and so are left out of Tables 2 and 3.

Table 3 shows a minimum number of lookup table entries for augmenting precision of arctangents as described herein over a range of 1 radian (180/π degrees) at the designated accuracies. Thus, Table 3 shows how many lookup table entries would be needed for the shift algorithm (discussed herein for example at blocks 320-335) to reach a designated accuracy using a particular polynomial.

TABLE 3
SIZE OF LOOKUP TABLE
Minimum table entries for 1 radian coverage:

| Accuracy | 1.00E−15 | 1.00E−14 | 1.00E−08 | 1.00E−07 |
|---|---|---|---|---|
| H2 Hermitian | 26 | 20 | 3 | 2 |
| H1 Hermitian | 549 | 346 | 21 | 13 |
| Cephes | 1,566 | 727 | 3 | 3 |
| Taylor Ser. Exp. | 88,496 | 40,816 | 405 | 188 |

The number of lookup table entries needed for the Cephes and Taylor series expansion polynomials are shown for comparison with the number of lookup table entries used for the Hermitian polynomials. The number of lookup table entries table entries in Table 3 is larger than in Table 1 because in the assessment applied in Table 2, the ranges are overly conservative. In Table 2, every single value in the range had to be accurate to the last bit of precision. Typically, this level of strictness is not enforced, as even the hardware is not accurate to the last bit most of the time. This allows for slightly wider ranges in which substantially all values in the range is accurate to the last bit of precision, with a few exceptions, and which allows for even fewer lookup table entries, as shown in Table 1. Tables 2 and 3 are an example to illustrate that a suitable precision range can be isolated, providing the fastest arctangent generation algorithm for a level of accuracy that is acceptable for a given application.

Interestingly, where the target accuracy is just single precision, using the Cephes series initially outperforms using the H1 series (although not the H2 series) because Cephes is designed to be single precision across most of its short, π/8 radian range. Thus, in one embodiment, the high-performance arctangent system can boost Cephes to single precision even outside of its range. But, using H1 rapidly outperforms using Cephes at accuracy levels beyond single precision.

### —Further Example High-Performance Arctangent Method—

FIG. 5 illustrates one embodiment of a high-performance arctangent method 500 associated with associated with high-performance arctangent computation at specified precision. In one embodiment, at block 505 high-performance arctangent method 500 creates a lookup table of pre-computed arctangent values that correspond to range segments of a working range of an arctangent approximation function. In one embodiment, the lookup table is created as described in lookup table generation method 200 of with reference to FIG. 2.

For example, high-performance arctangent method creates a lookup table having a number K of entries T[i]. The entries T[i] are indexed in the lookup table with index i, with values of i between 1 and K, inclusive. In one embodiment, the working range of the arctangent approximation polynomial is subdivided into K range segments. In one embodiment, the values of index i correspond to the range segments in an ascending order of distance from a zero angle over the working range. Thus, for example, index 1 corresponds to a first range of the arctangent approximation polynomial that begins at angle 0, index 2 corresponds to a second range of the arctangent approximation polynomial that is separated from angle 0 by the first range, and so on.

The entries T[i] for each index position i are the arctangents of the quotient of i divided by the number K of entries. The quotient of i divided by the number K of entries describes an angle in radians. The arctangents are computed at a specified target level of precision. The arctangents corresponding to each range of the arctangent approximation polynomial are thus pre-computed. Each pre-computed arctangent is then stored at an index position in the lookup table that associates the pre-computed arctangent with a corresponding range.

In one embodiment, this production of a lookup table is a one-time, offline pre-processing step. The completed lookup table will be used in support of multiple iterations of subsequent method steps. The completed lookup table will be placed in proximate memory for rapid access by subsequent method steps. Thus, in one embodiment, at the conclusion of block 505, a lookup table for augmenting precision of the arctangent approximation polynomial has been generated.

In one embodiment, high-performance arctangent method 500 begins a live or real-time arctangent generation process at start block 510. Arctangent generation begins at start block 510 in response to receiving an angle A for which an arctangent is to be generated, and proceeds to block 515.

In one embodiment, at block 515 high-performance arctangent method 500 brackets an angle to a working range of the arctangent approximation polynomial. In one embodiment, the working range is a positive principal range of the arctangent approximation polynomial between the angles of 0 and π/2 radians (0 to 90 degrees) inclusive. In one embodiment, the working range is a range of the arctangent approximation polynomial between the angles of 0 and 1 radians (0 to 180/π degrees) inclusive. Other working ranges may also be appropriate.

In one embodiment, the angle is bracketed within the working range by angle-shifting the angle into the specified range. In one embodiment, the angle A is shifted into a working range defined or bounded by a minimum allowed value (min_range) and a maximum allowed value (max_range) for the arctangent function. For example, the working range may have a min_range of 0 radians, and max_range of 1 radian. A difference between the maximum allowed value (max_range) and the minimum allowed value (min_range) for the arctangent function is calculated (range_difference=max_range-min_range). Where angle A is less than min_range, range_difference is added to angle A, and where angle A is greater than max_range, range_difference is subtracted from angle A. Following this process, the angle is bracketed to the working range. In one embodiment, the steps of block 515 are performed by angle shifter 145.

In one embodiment, at block 520 high-performance arctangent method 500 determines a closest index of a lookup table to the bracketed angle. The lookup table has an index position for each of a plurality of range segments of the working range. As discussed above with reference to block 505, there are K range segments in the plurality of range segments and K corresponding index positions. In one embodiment, the closest index is found by multiplying the bracketed angle A by the number K, and truncating the result. In particular, the product of bracketed angle A and number K of range segments/index positions is truncated to the working range. In one embodiment, the truncation is performed by modulo division of the product of bracketed angle A and number K by the range difference of the working range to produce the remainder. The remainder is the truncated angle (truncated_angle=(A×K) % range_difference). The truncated angle is compared to the boundaries of the range segments to determine which of the K range segments the truncated angle falls within. The index that is associated with the range segment that the truncated angle occurs within is then set as the closest index (idx) of the lookup table to the bracketed angle. In one embodiment, the steps of block 520 are performed by angle shifter 145.

In one embodiment, at block 525 high-performance arctangent method 500 generates an angle shift for the bracketed angle that is configured to move the bracketed angle to a high-precision segment of the range segments. In the high-precision segment the arctangent approximation polynomial approximates the arctangent function within a specified precision. In one embodiment, the high-precision segment is a range segment closest or nearest to the zero angle. As may be seen with reference to the H1 and H2 Hermitian polynomial approximations above, the precision of the arctangent approximation polynomial is highest as the angle approaches 0. In one embodiment, the specified level of precision may be pre-set to a target level of precision. The high-precision range includes angles where the arctangent approximation polynomial approximates the arctangent function with residuals within the specified precision.

In one embodiment, the angle shift S is generated by multiplying the closest index (idx) by the constant R/K, where R is the size of the working range (range_distance). R may be, for example, 1 radian, π/2 radians, or any other width. This angle shift will place any given bracketed angle into the high-precision segment (segment 1 of the K range segments). In one embodiment, the steps of block 525 are performed by angle shifter 145.

In one embodiment, at block 530 high-performance arctangent method 500 generates a shifted angle based on the bracketed angle and the angle shift. The shifted angle is in the high-precision segment. In one embodiment, the shifted angle θ is generated by dividing the difference between the bracketed angle A and the angle shift S by the sum of 1 and the product of the bracketed angle A and the angle shift S (θ=(A−S)/(1+A×S)). In one embodiment, the steps of block 530 are performed by angle shifter 145.

In one embodiment, at block 535 high-performance arctangent method 500 evaluates the arctangent approximation polynomial at the shifted angle to produce an estimated arctangent of the shifted angle. The value of the shifted angle θ is substituted for the variable in the arctangent approximation polynomial, and the arithmetic operations described by the arctangent approximation polynomial are carried out for the value of the shifted angle θ. The result is the estimated arctangent for the shifted angle. Because the shifted angle θ is within the high-precision range, the estimated arctangent of θ has no less than the specified precision. In one embodiment, the steps of block 535 are performed by polynomial evaluator 150.

In one embodiment, at block 540 high-performance arctangent method 500 (i) retrieves a pre-computed arctangent corresponding to the closest index in the lookup table from proximate memory and (ii) generates an augmented-precision arctangent from the estimated arctangent and the pre-computed arctangent. In one embodiment, high-performance arctangent method 500 selects the pre-computed arctangent stored at the closest index (idx) to the bracketed angle in the lookup table. The pre-computed arctangent has no less than the specified precision. The lookup table is stored in proximate memory (such as a register) to minimize the latency of the retrieval. As discussed above, the lookup table is sized so as to fit within proximate memory. In one embodiment, the retrieval of the pre-computed arctangent is performed by arctangent retriever 155.

With the pre-computed arctangent at the closest index (idx) retrieved, high-performance arctangent method 500 then adds the pre-computed arctangent and the estimated arctangent to produce the augmented-precision arctangent. Because the estimated arctangent and the pre-computed arctangent are both of at least the specified precision, the resulting augmented-precision arctangent also has at least the specified precision. In one embodiment, the generation of the augmented-precision arctangent is performed by approximation offsetter 160.

At the conclusion of block 540, high-performance arctangent method 500 may repeat from start block 510 while there is a new angle A for arctangent generation. Or where there is no further angle A for arctangent generation, high-performance arctangent method 500 may proceed to end block 545 and terminate.

Thus, in one embodiment, the precision of a polynomial estimate of an arctangent of an angle may be augmented to a specified level of precision using constant-time lookup and shifting operations that are many times faster than direct calculation of the arctangent to the specified level of precision. The high-performance arctangent system therefore provides rapid, real-time performance of individual or bulk arctangent calculations at high levels of precision. This allows operations that rely on bulk high-precision arctangent evaluations to be implemented in real-time or streaming domains, where such real-time operation was not previously possible. This improvement is due to the novel systems and methods described herein for high-performance arctangent production, and not by brute force application of computing power. Instead, (i) use of an arctangent approximation polynomial with a range of arbitrarily high precision and (ii) partitioning a working range of the polynomial in a manner that allows a lookup table offset arctangents for each range to fit in proximate memory reduce both memory latency and processor cycles, requiring less clock time and processor time to achieve greater precision.

### —Improvement to Low-Precision Machines—

NVIDIA GPUs are a type of processor commonly used for bulk parallel computations. NVIDIA GPUs lack good double (64-bit) precision support. NVIDIA GPUs are inherently low-precision machines. In one embodiment, the high-performance arctangent system can be used to bring arctangent calculations performed on NVIDIA GPUs (or other low-precision machines) to full double precision without modification or replacement of the hardware. The ability of the high-performance arctangent system to arbitrarily set arctangent precision enables machines without native support for double precision to produce arctangents at double precision.

### —Cloud or Enterprise Embodiments—

In one embodiment, the present system (such as high-performance arctangent system 100) is a computing/data processing system including a computing application or collection of distributed computing applications for access and use by other client computing devices that communicate with the present system over a network. In one embodiment, high-performance arctangent system 100 is a component of a time series data service that is configured to gather, serve, and execute operations on time series data. The applications and computing system may be configured to operate with or be implemented as a cloud-based network computing system, an infrastructure-as-a-service (IAAS), platform-as-a-service (PAAS), or software-as-a-service (SAAS) architecture, or other type of networked computing solution. In one embodiment the present system provides at least one or more of the functions disclosed herein and a graphical user interface to access and operate the functions. In one embodiment, high-performance arctangent system 100 is a centralized server-side application that provides at least the functions disclosed herein and that is accessed by many users by way of computing devices/terminals communicating with the computers of high-performance arctangent system 100 (functioning as one or more servers) over a computer network. In one embodiment, high-performance arctangent system 100 may be implemented by a server or other computing device configured with hardware and software to implement the functions and features described herein.

In one embodiment, the components of high-performance arctangent system 100 may be implemented as sets of one or more software modules executed by one or more computing devices specially configured for such execution. In one embodiment, the components of high-performance arctangent system 100 are implemented on one or more hardware computing devices or hosts interconnected by a data network. For example, the components of high-performance arctangent system 100 may be executed by network-connected computing devices of one or more computing hardware shapes, such as central processing unit (CPU) or general-purpose shapes, dense input/output (I/O) shapes, graphics processing unit (GPU) shapes, and high-performance computing (HPC) shapes.

In one embodiment, the components of high-performance arctangent system 100 intercommunicate by electronic messages or signals. These electronic messages or signals may be configured as calls to functions or procedures that access the features or data of the component, such as for example application programming interface (API) calls. In one embodiment, these electronic messages or signals are sent between hosts in a format compatible with transmission control protocol/internet protocol (TCP/IP) or other computer networking protocol. Components of high-performance arctangent system 100 may (i) generate or compose an electronic message or signal to issue a command or request to another component, (ii) transmit the message or signal to other components of high-performance arctangent system 100, (iii) parse the content of an electronic message or signal received to identify commands or requests that the component can perform, and (iv) in response to identifying the command or request, automatically perform or execute the command or request. The electronic messages or signals may include queries against databases. The queries may be composed and executed in query languages compatible with the database and executed in a runtime environment compatible with the query language.

In one embodiment, remote computing systems may access information or applications provided by high-performance arctangent system 100, for example through a web interface server. In one embodiment, the remote computing system may send requests to and receive responses from high-performance arctangent system 100. In one example, access to the information or applications may be effected through use of a web browser on a personal computer or mobile device. In one example, communications exchanged with high-performance arctangent system 100 may take the form of remote representational state transfer (REST) requests using JavaScript object notation (JSON) as the data interchange format for example, or simple object access protocol (SOAP) requests to and from XML servers. The REST or SOAP requests may include API calls to components of high-performance arctangent system 100.

### —Software Module Embodiments—

In general, software instructions are designed to be executed by one or more suitably programmed processors accessing memory. Software instructions may include, for example, computer-executable code and source code that may be compiled into computer-executable code. These software instructions may also include instructions written in an interpreted programming language, such as a scripting language.

In a complex system, such instructions may be arranged into program modules with each such module performing a specific task, process, function, or operation. The set of modules may be controlled or coordinated in their operation by an operating system (OS) or other form of organizational platform.

In one embodiment, one or more of the components described herein are configured as modules stored in a non-transitory computer readable medium. The modules are configured with stored software instructions that when executed by at least a processor accessing memory or storage cause the computing device to perform the corresponding function(s) as described herein.

### —Computing Device Embodiment—

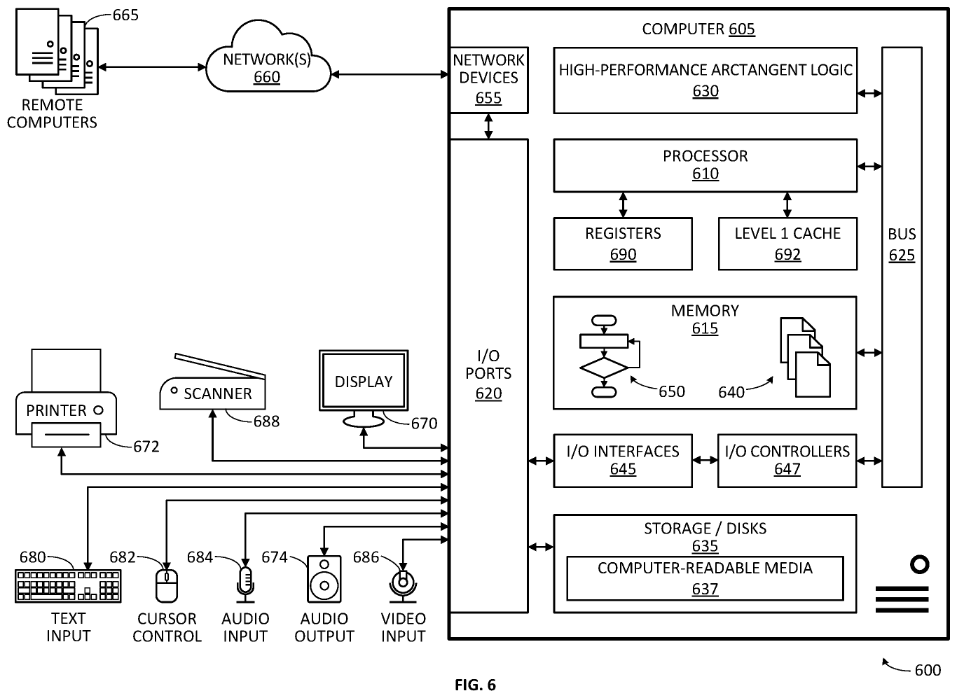

FIG. 6 illustrates an example computing system 600 that is configured and/or programmed as a special purpose computing device(s) with one or more of the example systems and methods described herein, and/or equivalents. The example computing device may be a computer 605 that includes at least one hardware processor 610, a memory 615, and input/output ports 620 operably connected by a bus 625. In one example, the computer 605 may include high-performance arctangent logic 630 configured to facilitate high performance arctangent computation at arbitrarily high precision, similar to systems, methods, logic, and other embodiments shown and described herein with reference to FIGS. 1-5.

In different examples, the logic 630 may be implemented in hardware, one or more non-transitory computer-readable media 637 with stored instructions, firmware, and/or combinations thereof. While the logic 630 is illustrated as a hardware component attached to the bus 625, it is to be appreciated that in other embodiments, the logic 630 could be implemented in the processor 610, stored in memory 615, or stored in disk 635.

In one embodiment, logic 630 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an application-specific integrated circuit (ASIC) programmed to facilitate high performance arctangent computation at arbitrarily high precision. The means may also be implemented as stored computer executable instructions that are presented to computer 605 as data 640 that are temporarily stored in memory 615 and then executed by processor 610.

Logic 630 may also provide means (e.g., hardware, non-transitory computer-readable medium that stores executable instructions, firmware) for performing one or more of the disclosed functions and/or combinations of the functions.

Generally describing an example configuration of the computer 605, the processor 610 may be a variety of various processors including dual microprocessor and other multi-processor architectures. A memory 615 may include volatile memory and/or non-volatile memory. Non-volatile memory may include, for example, read-only memory (ROM), programmable ROM (PROM), and so on. Volatile memory may include, for example, random access memory (RAM), static RAM (SRAM), dynamic RAM (DRAM), and so on.

A storage disk 635 may be operably connected to the computer 605 via, for example, an input/output (I/O) interface (e.g., card, device) 645 and an input/output port 620 that are controlled by at least an input/output (I/O) controller 647. The disk 635 may be, for example, a magnetic disk drive, a solid-state drive, a floppy disk drive, a tape drive, a Zip drive, a flash memory card, a memory stick, and so on. Furthermore, the disk 635 may be a compact disc ROM (CD-ROM) drive, a CD recordable (CD-R) drive, a CD rewritable (CD-RW) drive, a digital video disc ROM (DVD ROM) drive, and so on. The storage/disks thus may include one or more non-transitory computer-readable media. The memory 615 can store a process 650 and/or a data 640, for example. The disk 635 and/or the memory 615 can store an operating system that controls and allocates resources of the computer 605.

The computer 605 may interact with, control, and/or be controlled by input/output (I/O) devices via the input/output (I/O) controller 647, the I/O interfaces 645, and the input/output ports 620. Input/output devices may include, for example, one or more network devices 655, displays 670, printers 672 (such as inkjet, laser, or 3D printers), audio output devices 674 (such as speakers or headphones), text input devices 680 (such as keyboards), cursor control devices 682 for pointing and selection inputs (such as mice, trackballs, touch screens, joysticks, pointing sticks, electronic styluses, electronic pen tablets), audio input devices 684 (such as microphones or external audio players), video input devices 686 (such as video and still cameras, or external video players), image scanners 688, video cards (not shown), disks 635, and so on. The input/output ports 620 may include, for example, serial ports, parallel ports, and USB ports.

The computer 605 can operate in a network environment and thus may be connected to the network devices 655 via the I/O interfaces 645, and/or the I/O ports 620. Through the network devices 655, the computer 605 may interact with a network 660. Through the network 660, the computer 605 may be logically connected to remote computers 665. Networks with which the computer 605 may interact include, but are not limited to, a local area network (LAN), a wide area network (WAN), and other networks.

The processor 610 may include one or more cores for electronically executing instructions and performing calculations. The processor 610 is connected with proximate memory such as registers 690 and level 1 (L1) cache 692 memory. Registers 690 are storage elements within the processor core(s), serving as holding areas for data and instructions accessed during calculations. L1 cache 692 is a small, high-speed memory integrated with the processor core(s) that acts as a buffer to store data and instructions at a low latency location. Instructions and data in binary may be physically retained in registers or L1 cache by maintaining a high or low voltage state to represent a 1 or zero, respectively, for each binary digit.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C. § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element, or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C. § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. A computing system, comprising:
a processor;
a level 1 cache or registers operably connected to the processor;
a memory operably connected to the processor; and
one or more non-transitory computer-readable media that include instructions stored thereon that when executed by at least the processor cause the computing system to:
identify an accurate range of an arctangent approximation polynomial in which a target level of precision is satisfied;
subdivide the arctangent approximation polynomial into a plurality of range segments for which one high-precision segment of the range segments remains within the accurate subrange;
for the plurality of range segments in ascending order,
pre-compute an arctangent that is configured to offset from the high-precision segment to the range segment, and
write the pre-computed arctangent to a lookup table in an index position corresponding to the order of the range segment;
store the lookup table in level 1 cache or registers; and
access one of the pre-computed arctangents from the lookup table in the level 1 cache or registers to augment precision of a polynomial approximation of an arctangent of an angle to the target level of precision.

2. The computing system of claim 1, wherein the instructions to pre-compute an arctangent further cause the computing system to, for each range segment, generate an arctangent of a ratio of an index position of the range segment to a total count of the plurality of range segments at the target level of precision to be the pre-computed arctangent.

3. The computing system of claim 1, wherein the instructions to access one of the pre-computed arctangents from the lookup table in the level 1 cache or registers to augment precision of a polynomial approximation of an arctangent of an angle to the target level of precision further cause the computing system to:
receive a request to generate the arctangent for the angle;
angle-shift the angle to the high-precision segment based on an index position in the lookup table of a range segment in which the angle occurs;
evaluating the arctangent approximation polynomial at the shifted angle to produce an approximate arctangent of the shifted angle;
retrieving the one of the pre-computed arctangents in the index position from the lookup table; and
offsetting the approximate arctangent of the shifted angle by the pre-computed arctangent in the index position to generate the arctangent for the angle at the target level of precision.

4. The computing system of claim 1, wherein the instructions to identify the accurate subrange further cause the computing system to identify the accurate subrange based on residuals between the arctangent function and the arctangent approximation polynomial.

5. The computing system of claim 1, wherein the instructions to subdivide the range into a number of range segments further cause the computing system to subdivide the range into a fewest segments for which the one high-precision segment of the range segments remains within the accurate subrange.

6. A computer-implemented method, comprising:
accessing, in proximate memory, a lookup table of pre-calculated arctangents that correspond by index to a plurality of range segments of an arctangent approximation polynomial, wherein the range segments include a high-precision segment at a target level of precision;
receiving a request to generate an arctangent for an angle;
angle-shifting the angle to the high-precision segment based on an index position in the lookup table of a range segment in which the angle occurs;
evaluating the arctangent approximation polynomial at the shifted angle to produce an approximate arctangent of the shifted angle;
retrieving the pre-computed arctangent for the index from the lookup table; and
offsetting the approximate arctangent of the shifted angle by the pre-computed arctangent for the index to generate the arctangent for the angle at the target level of precision.

7. The computer-implemented method of claim 6, wherein evaluating the arctangent approximation polynomial at the shifted angle augments a precision of the generated arctangent for the angle.

8. The computer-implemented method of claim 6,
wherein the target level of precision is 32-bit precision, and
wherein the arctangent for the angle is generated at the target level of precision using no more than two pre-computed arctangents in the lookup table.

9. The computer-implemented method of claim 6,
wherein the target level of precision is 64-bit precision, and
wherein the arctangent for the angle is generated at the target level of precision using no more than 16 pre-computed arctangents in the lookup table.

10. The computer-implemented method of claim 6, further comprising maintaining the lookup table in registers or level 1 cache.

11. The computer-implemented method of claim 6, wherein the arctangent approximation polynomial is a Hermitian polynomial.

12. The computer-implemented method of claim 6, wherein the high-precision segment covers angles nearest to zero out of the plurality of range segments.

13. The computer-implemented method of claim 6, further comprising generating a light transformation in 3D rendering, executing an activation function in a neural network using the generated arctangent.

14. The computer-implemented method of claim 6, wherein the arctangent is generated in real time at the target level of precision.

15. The computer-implemented method of claim 6, further comprising computing the pre-computed arctangents at or beyond the target level of precision.

16. The computer implemented method of claim 6, wherein prior to angle-shifting the angle to the high-precision segment, the method further comprises bracketing the angle to a working range of the arctangent approximation polynomial.

17. One or more non-transitory computer-readable media that include instructions stored thereon that when executed by at least a processor of a computing system cause the computing system to:
bracket an angle to a working range of an arctangent approximation polynomial;
determine a closest index of a lookup table to the bracketed angle, wherein the lookup table has an index position for each of a plurality of range segments of the working range;
generate an angle shift for the bracketed angle that is configured to move the bracketed angle to a high-precision segment of the range segments, wherein in the high-precision segment the arctangent approximation polynomial approximates the arctangent function within a specified precision;
generate a shifted angle based on the bracketed angle and the angle shift, wherein the shifted angle is in the high-precision segment;
evaluate the arctangent approximation polynomial at the shifted angle to produce an estimated arctangent of the shifted angle;
retrieve a pre-computed arctangent corresponding to the closest index in the lookup table from proximate memory; and
generate an augmented-precision arctangent from the estimated arctangent and the pre-computed arctangent.

18. The non-transitory computer-readable media of claim 17, wherein the instructions further cause the computing system to create the lookup table of pre-computed arctangent values that correspond to the range segments of the working range of the arctangent approximation function.

19. The non-transitory computer-readable media of claim 17, wherein the arctangent approximation polynomial is the H1 Hermitian polynomial or the H2 Hermitian polynomial.

20. The non-transitory computer-readable media of claim 17, wherein the augmented-precision arctangent is generated in real time at the target level of precision for a plurality of angles.
